(19) United States
(12) Patent Application Publication
(10) Pub. No.: US 2014/0214496 A1
(43) Pub. Date: Jul. 31, 2014

(54) DYNAMIC PROFITABILITY MANAGEMENT FOR CLOUD SERVICE PROVIDERS

(71) Applicant: HEWLETT-PACKARD DEVELOPMENT COMPANY, L.P., Houston, TX (US)

(72) Inventors: Keith Stewart Rattray Macbeath, Fort Lee, NJ (US); Emil S. Frisendal, Paris (FR)

(73) Assignee: Hewlett-Packard Development Company, L.P., Houston, TX (US)

(21) Appl. No.: 13/756,193

(22) Filed: Jan. 31, 2013

(51) Int. Cl. G06Q 30/02

(52) U.S. Cl. CPC G06Q 30/0283
USPC 705/7.37

(57) ABSTRACT

An example method for dynamic profitability management for cloud service providers can include utilizing a processing resource to execute instructions stored on a medium to recommend adjustment of prices for a number of cloud services provided by a cloud service provider to manage profitability based upon analyzing input of input profiles. The input profiles can include a market price profile per workload unit, a behavioral profile per customer, a scheduled workload profile per offered cloud service, and a workload capacity profile per cloud service placement option.

### BACKGROUND

For cloud service providers, dynamic price adjustment may drive enhancement of revenue per production unit (e.g., yield management). The task of adjusting the prices may be complex because it may involve consideration of a large set of parameters. To address this challenge, each of the parameters may be analyzed individually and collectively as contributors. However, this may not enable a rapid and automatic yield enhancement that takes into account other factors, such as costs. Thus, the cloud service provider may not be adjusting prices such that the prices would effectively increase overall profit for the cloud service provider's offerings in the marketplace.

### BRIEF DESCRIPTION OF THE DRAWINGS

FIG. 1 illustrates a block diagram of an example method for dynamic profitability management for cloud service providers according to the present disclosure.

FIG. 2 illustrates a block diagram of an example system for dynamic profitability management for cloud service providers according to the present disclosure.

FIG. 3 illustrates a block diagram of an example computing system for dynamic profitability management for cloud service providers according to the present disclosure.

### DETAILED DESCRIPTION

The present disclosure describes dynamic profitability management for cloud service providers that can enable automatic price adjustment recommendations for cloud service offerings to enhance profitability based upon input and consideration of a variety of parameters. Such parameters can be included in input profiles such as, for example, current workloads per service and/or per customer, forecasted workloads, current and/or forecasted production costs, customer behavioral patterns, competitor/market prices per workload unit, among others described herein. The price adjustment recommendations can, for example, be performed based upon an overall portfolio of cloud service offerings, based upon offerings to individual customers, and/or based upon characteristics of individual requests, among other considerations. The dynamic profitability management can provide pricing adjustment recommendations that can (e.g., if enabled by the cloud service provider) be directly applied to the catalog of cloud service offers, which can increase profitability (e.g., a profit yield) of the cloud service provider's resources in a faster, more accurate, and more comprehensive manner compared to, for example, a human analyst.

Systems, machine readable media, and methods for dynamic profitability management for cloud service providers are provided. An example method can include utilizing a processing resource to execute instructions stored on a non-transitory medium to recommend adjustment of prices for a number of cloud services provided by (e.g., offered and/or executable by) a cloud service provider to manage profitability based upon analyzing (e.g., processing) input profiles that have been input and the relationship of the input profiles to one other. The input profiles can include a market price profile per workload unit, a behavioral profile per customer, a scheduled workload profile per offered cloud service, and a workload capacity profile per cloud service placement option, as described herein.

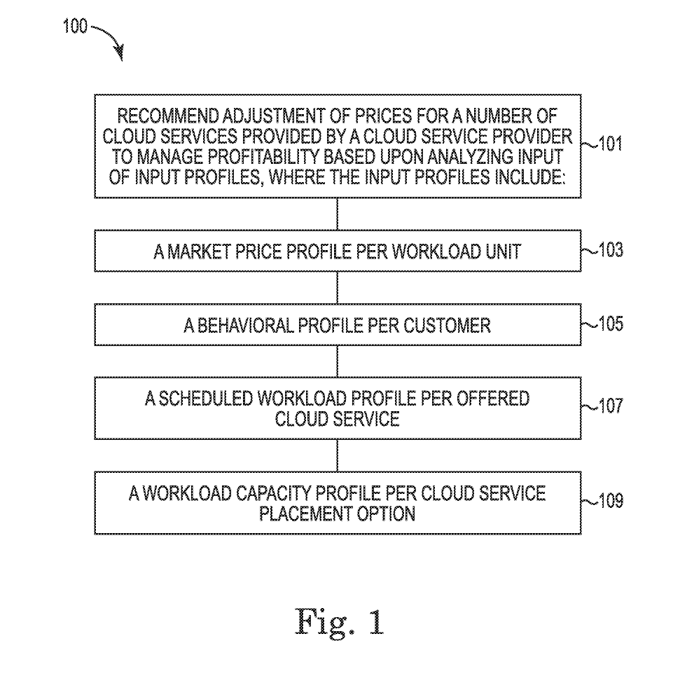

FIG. 1 illustrates a block diagram of an example method for dynamic profitability management for cloud service providers according to the present disclosure. Unless explicitly stated, the method examples described herein are not constrained to a particular order or sequence. Additionally, some of the described method examples, or elements thereof, can be performed at the same, or substantially the same, point in time. As described herein, the actions, functions, calculations, data manipulations and/or storage, etc., can be performed by execution of non-transitory machine readable instructions stored in a number of memories (e.g., software, firmware, and/or hardware, etc.) of a number of applications. As such, a number of computing resources with a number of interfaces (e.g., graphical user interfaces (GUIs)) can be utilized for dynamic profitability management for cloud service providers (e.g., via accessing a number of computing resources in “the cloud” via the GUIs).

In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, and/or structural changes may be made without departing from the scope of the present disclosure. As used herein, “a” or “a number of” an element and/or feature can refer to one or more of such elements and/or features. Further, where appropriate, as used herein, “for example” and “by way of example” should be understood as abbreviations for “by way of example and not by way of limitation”.

The figures herein follow a numbering convention in which the first digit or digits correspond to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

The present disclosure describes dynamic profitability management for cloud service providers that can increase profitability (e.g., the profit yield) of the cloud service provider's resources, Adjustment of the prices for the service offerings in the cloud service provider's catalog is one way to increase the profitability. The price of each offering can consist of a plurality of individual price components (e.g., input profiles), some or all of which can be considered, as applicable to particular circumstances. The computing resources and/or business analysts can consider which of the input profiles are likely to influence overall profitability of the cloud service offerings. The following non-exhaustive list illustrates input profiles, as described herein, for consideration by the computing resources in recommending adjustment of prices to manage profitability: current compute workload profiles per service and/or per customer, where a workload profile can be a set of metrics describing the actual workload, such as central processing unit (CPU) usage metrics, memory usage metrics, among other such metrics; historical and/or forecasted compute workload profiles per service and/or per customer; historical and/or projected (e.g., predicted) customer behavior as related to price adjustments; market and/or competitor price information as a market price profile per workload unit; current and/or forecasted production cost information for underlying infrastructure (e.g., the cost to produce each cloud service instance/unit); current and/or forecasted workload capacity profile per cloud service placement option (e.g., a capacity and/or ability to handle various amounts and/or types of workloads at a number of cloud service activity sub-providers in various placement options around the world); and/or service catalog details (e.g., definitions, price components, service levels, etc.); among other input profiles described herein.

Output of the computing resources can include recommendation of the adjusted prices, which can be automatically applied (e.g., based on user preferences) to the service catalog, where the offerings can have many price components. Alternatively or in addition, the output can include a set of recommended changes to be applied to the catalog manually (e.g., by an authorized representative of the cloud service provider). Computing resource applications can record a history of customer behavior as affected over time based on a number of price adjustments. Analysis of the history of customer behavior relative to the price adjustments can be input as an input profile for consideration of potential price adjustment recommendations to improve predictability of customer behavior (e.g., a likelihood of a customer purchasing a cloud service offering after a price for the offering has been adjusted upwards relative to a previous purchase and/or a competitor's price). Alternatively or in addition, a history of customer behavior can be analyzed and input relative to adjustments to placement options (e.g., alternative venues for workload execution), workflow performance execution parameters (e.g., relative to sizing and/or scaling, as described herein), among other considerations that can affect customer behavior relative to purchasing a cloud service.

As most of the input profiles can experience rapid and/or frequent changes, the task of dynamic profitability management for cloud service providers can be a continuing, iterative process. As such, after any input profile changes, a new iteration can be initiated. However, based upon a cloud service provider's preferences, an authorized representative can choose whether the computing resource makes and/or implements the price adjustment recommendations continually (e.g., in real-time), as scheduled (e.g., daily or any other periodicity), or as being event-driven (e.g., based on specified events tied to changes in the input profiles).

Accordingly, as shown in block 101 of FIG. 1, the method 100 for dynamic profitability management for cloud service providers can include utilizing a processing resource to execute instructions stored on a non-transitory medium to recommend adjustment of prices for a number of cloud services provided by (e.g., offered and/or executable by) a cloud service provider to manage profitability based upon analyzing input of input profiles. In some examples of the present disclosure, the input profiles include a market price profile per workload unit, as shown in block 103, a behavioral profile per customer, as shown in block 105, a scheduled workload profile per offered cloud service, as shown in block 107, and a workload capacity profile per cloud service placement option, as shown in block 109.

As described herein, a market price profile per workload unit is input instead of published price lists per workload component (e.g., as determined by analysis of a range of cloud service providers' catalogs). Given the dynamic nature of cloud service, an ability to estimate and/or manage cost and/or capacity is a concern for cloud service providers and customers. By way of example and not by way of limitation, a market price per workload unit can, for example, be estimated by automatically analyzing a cloud service application's cost by creating and running load tests with a system that mimics a real workload that the application would experience. During these tests, the system can automatically learn the cost of running the application in the cloud environment as a function of the workload and a cloud service provider's pricing. This analysis can yield accurate estimates and allow for planning of various workload scenarios that may arise in the future.

An overview of an example of the flow of such a system can be described as follows. The expected workloads are defined. A workload can be provided in the form of specific scenarios that simulate real demand patterns. Workload learning components can create these based on recording real user interaction with an application, when such exists. The workloads can be simulated in a sandbox environment in the cloud. A simulated number of users can be increased to allow detection of performance degradation and actions to mitigate the degradation. The application can be continuously monitored (e.g., at application and system levels) and the monitored results can be fed into a detection module that detects and characterizes performance anomalies. Workload information can be collected and stored in a database. Relevant user metrics can also be stored. A reasonably accurate estimate of the market price per workload unit for a given scenario and demand volume (e.g., number of users) can be determined. Linear interpolation can assist in determining a market price profile per workload unit. Alternatively or in addition, a market price profile per workload unit estimate can be based upon service templates and/or historical use per service per customer.

In various examples, a number of additional input profiles usable as input to recommend adjustment of prices for the number of cloud services can be selected. The number of additional profiles (e.g., one or more) can be selected from a group that includes: a workload timing profile per cloud service; a contract profile per customer per cloud service; a scaling rule profile per cloud service; a sizing rule profile per cloud service; a cost profile per cloud service placement option; and/or a service catalog profile, as described herein.

The scheduled workload profile per offered cloud service can, for example, be a scheduling of types and/or amounts of workloads for each cloud service offered by the cloud service provider and/or sub-providers. The workload timing profile per cloud service can, for example, be a scheduling of jobs (e.g., actually scheduled jobs and/or a forecast of scheduling based upon, for example, historical trends) for a particular cloud service, or portions thereof, at various times throughout the day, week, month, year, etc. The workload timing profile per offered cloud service can reflect peaks and valleys in a level of activity per cloud service (e.g., relative to an average), which can be utilized in recommendation of price adjustments. For example, less busy periods, as determined by the workload timing profile per cloud service can contribute to recommendation of a decreased price for the cloud service to lead to increased use of the cloud service's capacity, along with increased income and possible profit. For example, more busy periods, as determined by the workload timing profile per cloud service can contribute to recommendation of an increased price for the cloud service, based upon supply and demand principles, to lead to increased profit.

The contract profile per customer per cloud service can, for example, include service level agreements and/or agreed upon maximum and minimum costs per service, among other components of business and service contracts. Content of such contract profiles for each customer can place limits on price and/or execution adjustments for the cloud services. Such limits can be more readily considered and/or implemented by the computing resources for dynamic profitability management for a cloud service provider, as described herein, when determining contracts for one or more cloud services offerings for a particular customer than when, for example, being considered by sales personnel.

The scaling rule profile per cloud service can present rules for adding and/or removing machines (e.g., computers, servers, virtual machines, etc.) as factors in adjusting pricing for particular cloud services and/or adjusting performance levels of particular cloud services. The sizing rule profile per cloud service can present rules for replacing machines (e.g., computers, servers, virtual machines, etc.) with other machines having different characteristics (e.g., age, wear level, memory, storage, speed, etc.) as factors in adjusting pricing for particular cloud services and/or adjusting performance levels of particular cloud services.

The cost profile per cloud service placement option can represent the cost to and/or charged by each of the number of cloud service activity sub-providers in various placement options around the world for performing the various amounts and/or types of cloud service workloads. For example, the cost for performing a particular cloud service activity at a sub-provider located on the Indian subcontinent can be less than the cost for performing the particular cloud service activity at a sub-provider located in New York City. As such, the cost profile per cloud service placement option can be used as input in adjusting pricing for particular cloud services and/or adjusting execution of particular cloud services.

The service catalog profile can be utilized as input. Input of the service catalog profile can enable the computing resources to reference cloud services and/or pricing listed therein. Alternatively or in addition, input of the service catalog profile can enable the computing resources to automatically adjust the pricing for the cloud services listed therein (e.g., in real-time based upon changes to any of the previously discussed profiles). Accordingly, the method 100 can include automatically adjusting pricing of a number of cloud services presentable to a customer in a service catalog based upon real-time input of the input profiles. For example, the real-time input of the input profiles can include real-time input of a number of changes, additions, deletions, etc., to one or more of the input profiles as the changes, additions, deletions, etc., happen and/or are entered into the profile. Any of the input profiles previously described can be individualized per customer.

As described herein, the method 100 for dynamic profitability management for cloud service providers can include recommending adjustment of execution resources for the number of cloud services based upon analyzing input of the input profiles, as previously described. Adjustment of the execution resources can be performed to enable adjustment of the prices (e.g., presentable to the customer) for the number of cloud services provided by (e.g., offered and/or executable by) the cloud service provider and/or to affect a profit margin for the cloud service provider. Adjustment of the execution resources can include choosing a particular placement option (e.g., sub-provider, venue, location, etc.), particular machinery options, timing, scheduling, etc., for performance of the cloud services. In some examples of the present disclosure, the input profiles include the market price profile per workload unit, the behavioral profile per customer, the scheduled workload profile per offered cloud service, and the workload capacity profile per cloud service placement option, as described herein. In some examples, the execution resources of the number of cloud services can be automatically adjusted based upon real-time input of the input profiles.

In various examples, a number of additional input profiles usable as input to recommend adjustment of execution resources for the number of cloud services can be selected. The number of additional profiles (e.g., one or more) can be selected from a group that includes: the workload timing profile per cloud service; the contract profile per customer per cloud service; the scaling rule profile per cloud service; the sizing rule profile per cloud service; the cost profile per cloud service placement option; and/or the service catalog profile, as described herein.

The present disclosure describes dynamic profitability management to enhance profitability (e.g., the profit margin) obtained by a cloud service provider for performance of cloud services. Enhancement of profitability can be achieved by adjusting pricing and/or adjusting execution to obtain any combination of the following: increased revenue (e.g., either through volume increase and/or price increase); increased unit margin (e.g., either through cost reduction and/or price increase); and/or increased working capital utilization (e.g., through increased utilization of pre-existing capacity); among other adjustments to pricing and/or execution described herein.

An example of a decision tree of the present disclosure is: Multiple automated information INPUTS of input profiles>Profit enhancement decision processing>Automated OUTPUTS of information outputs (e.g., recommended pricing adjustments) and execution outputs (e.g., determination of adjustments to execution placement and/or execution performance parameters, as described herein).

As such, the present disclosure focuses on profit enhancement for the cloud service provider with a combination of multiple input types (e.g., the input profiles) and multiple output types (e.g., the information output types and/or the execution output types utilized for adjusting execution parameters and/or adjusting execution placement). The input profiles can include use of market price per workload unit as a basis for competitor pricing analysis as opposed to published price lists per component, a behavioral profile per customer (e.g., responses to price adjustments and/or changes in execution related to cloud service offerings), a contract profile per customer per cloud service, among the other input profiles described herein. The output can include information output to recommend raising of prices (e.g., to increase per workload margin) and/or to recommend lowering of prices (e.g., to increase volume of workloads executed and, hence, revenue). The information output can be automatically implemented by revising the prices per cloud service, or components thereof, in a service catalog presentable to a number of customers (e.g., accessible on-line). The output can also include execution output to adjust an execution method (e.g., for cost reduction to increase per workload margin) and/or to adjust execution placement (e.g., for capacity utilization enhancement and, hence, working capital utilization).

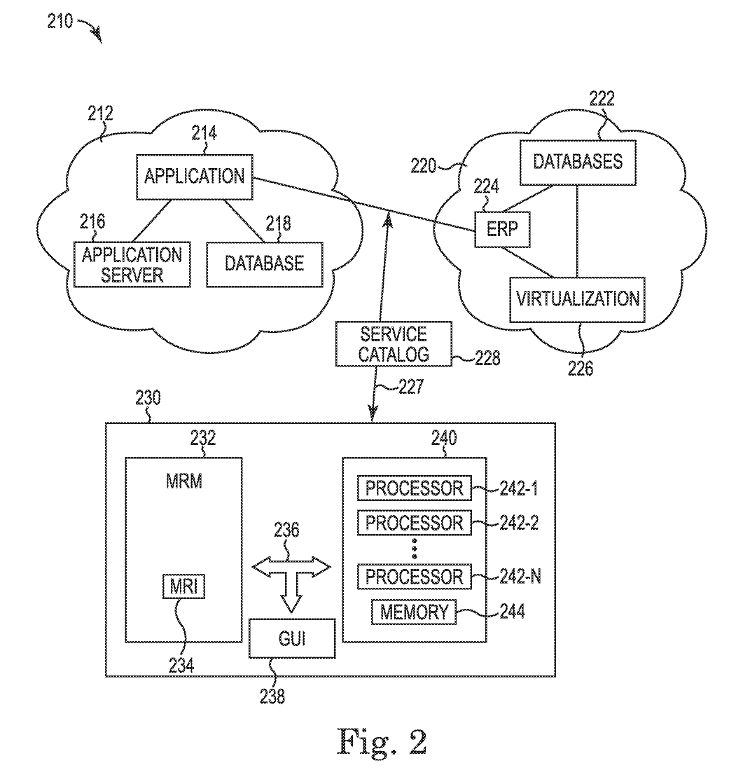

FIG. 2 illustrates a block diagram of an example system for dynamic profitability management for cloud service providers according to the present disclosure. An example system 210 for dynamic profitability management for cloud service providers is described below as being implemented in the cloud by way of example and not by way of limitation. That is, in some examples of the present disclosure, dynamic profitability management for cloud service providers can be performed (e.g., at least partially) within an organization utilizing applications, as described herein, accessible and usable through wired communication connections in addition or as an alternative to through wireless communications.

In some examples, the system 210 illustrated in FIG. 2 can include a number of cloud systems. In some examples, the number of clouds can include a public cloud system 212 and a private cloud system 220. For example, an environment (e.g., an information technology (IT) environment for dynamic profitability management for cloud service providers) can include a public cloud system 212 and a private cloud system 220 that can include a hybrid environment and/or a hybrid cloud. A hybrid cloud, for example, can include a mix of physical server systems and dynamic cloud services (e.g., a number cloud servers). For example, a hybrid cloud can involve interdependencies between physically and logically separated services consisting of multiple systems. A hybrid cloud, for example, can include a number of clouds (e.g., two clouds) that can remain unique entities but that can be bound together.

The public cloud system 212, for example, can include a number of applications 214, an application server 216, and a database 218. The public cloud system 212 can include a service provider (e.g., the application server 216) that makes a number of the applications 214 and/or resources (e.g., the database 218) available to users (e.g., accessible and/or modifiable by business analysts, authorized representatives, sub-providers, and/or customers, among others) over the Internet, for example. The public cloud system 212 can be free or offered for a fee. For example, the number of applications 214 can include a number of resources available to the users over the Internet. The users can access a cloud-based application through a number of GUIs 238 (e.g., via an Internet browser). An application server 216 in the public cloud system 210 can include a number of virtual machines (e.g., client environments) to enable dynamic profitability management for cloud service providers, as described herein. The database 218 in the public cloud system 212 can include a number of databases that operate on a cloud computing platform.

The private cloud system 220 can, for example, include an Enterprise Resource Planning (ERP) system 224, a number of databases 222, and virtualization 226 (e.g., a number of virtual machines, such as client environments, to enable dynamic profitability management for cloud service providers, as described herein). For example, the private cloud system 220 can include a computing architecture that provides hosted services to a limited number of nodes (e.g., computers and/or virtual machines thereon) behind a firewall. The ERP 224, for example, can integrate internal and external information across an entire business unit and/or organization (e.g., of a cloud service provider). The number of databases 222 can include an event database, an event archive, a central configuration management database (CMDB), a performance metric database, and/or databases for a number of input profiles, among other databases. Virtualization 226 can, for example, include the creation of a number of virtual resources, such as a hardware platform, an operating system, a storage device, and/or a network resource, among others.

In some examples, the private cloud system 220 can include a number of applications and/or an application server, as described for the public cloud system 212. In some examples, the private cloud system 220 can similarly include a service provider that makes a number of the applications and/or resources (e.g., the databases 222 and/or the virtualization 226) available for free or for a fee (e.g., to business analysts, authorized representatives, sub-providers, and/or customers, among others) over, for example, a local area network (LAN), a wide area network (WAN), a personal area network (PAN), and/or the Internet, among others. The public cloud system 212 and the private cloud system 220 can be bound together, for example, through one or more of the number of applications (e.g., 214 in the public cloud system 212) and/or the ERP 224 in the private cloud system 220 to enable dynamic profitability management for cloud service providers, as described herein.

The system 210 can include a number of computing devices 230 (e.g., a number of IT computing devices, system computing devices, and/or cloud service computing devices, among others) having machine readable memory (MRM) resources 232 and processing resources 240 with machine readable instructions (MRI) 234 (e.g., computer readable instructions) stored in the MRM 232 and executed by the processing resources 240 to, for example, enable dynamic profitability management for cloud service providers, as described herein. In various examples, at least some of the number of computing devices 230 can form a system physically separate from a number of the applications and/or application servers associated with the private cloud system 220 and/or the public cloud system 212 (e.g., to enable dynamic interaction between a cloud service provider and a number of cloud service sub-providers for profitability management).

The computing devices 230 can be any combination of hardware and/or program instructions (e.g., MRI) configured to, for example, enable the dynamic profitability management for cloud service providers, as described herein. The hardware, for example, can include a number of GUIs 238 and/or a number of processing resources 240 (e.g., processors 242-1, 242-2, . . . , 242-N), the MRM 232, etc. The processing resources 240 can include memory resources 244 and the processing resources 240 (e.g., processors 242-1, 242-2, . . . , 242-N) can be coupled to the memory resources 244. The MRI 234 can include instructions stored on the MRM 232 that are executable by the processing resources 240 to execute one or more of the various actions, functions, calculations, data manipulations and/or storage, etc., as described herein.

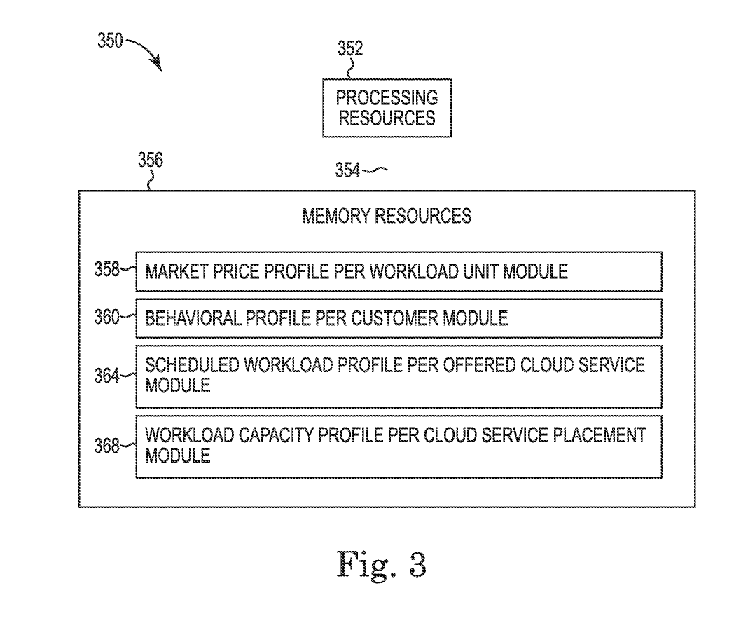

The computing devices 230 can include the MRM 232 in communication through a communication path 236 with the processing resources 240. For example, the MRM 232 can be in communication through a number of application servers (e.g., Java® application servers) with the processing resources 240. The computing devices 230 can be in communication with a number of tangible non-transitory MRMs 232 storing a set of MRI 234 executable by one or more of the processors (e.g., processors 242-1, 242-2, . . . , 242-N) of the processing resources 240. The MRI 234 can also be stored in remote memory managed by a server and/or can represent an installation package that can be downloaded, installed, and executed. The MRI 234, for example, can include and/or be stored in a number of modules as described with regard to FIG. 3.

Processing resources 240 can execute MRI 234 that can be stored on an internal or external non-transitory MRM 232. The non-transitory MRM 234 can be integral, or communicatively coupled, to the computing devices 230, in a wired and/or a wireless manner. For example, the non-transitory MRM 232 can be internal memory, portable memory, portable disks, and/or memory associated with another computing resource. A non-transitory MRM (e.g., MRM 232), as described herein, can include volatile and/or non-volatile storage (e.g., memory). The processing resources 240 can execute MRI 234 to perform the actions, functions, calculations, data manipulations and/or storage, etc., as described herein. For example, the processing resources 240 can execute MRI 234 to enable dynamic profitability management for cloud service providers, as described herein.

The MRM 232 can be in communication with the processing resources 240 via the communication path 236. The communication path 236 can be local or remote to a machine (e.g., computing devices 230) associated with the processing resources 240. Examples of a local communication path 236 can include an electronic bus internal to a machine (e.g., a computer) where the MRM 232 is volatile, non-volatile, fixed, and/or removable storage medium in communication with the processing resources 240 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 236 can be such that the MRM 232 can be remote from the processing resources 240, such as in a network connection between the MRM 232 and the processing resources 240. That is, the communication path 236 can be a number of network connections. Examples of such network connections can include LAN, WAN, PAN, and/or the Internet, among others. In such examples, the MRM 232 can be associated with a first computing device and the processing resources 240 can be associated with a second computing device (e.g., computing devices 230). For example, such an environment can include a public cloud system (e.g., 210) and/or a private cloud system (e.g., 220) to enable dynamic profitability management for cloud service providers, as described herein.

In various examples, the processing resources 240, the memory resources 232 and/or 244, the communication path 236, and/or the GUIs 238 associated with the computing devices 230 can have a connection 227 (e.g., wired and/or wirelessly) to a public cloud system (e.g., 212) and/or a private cloud system (e.g., 220). The connection 227 can, for example, enable the computing devices 230 to directly and/or indirectly control (e.g., via the MRI 234 stored on the MRM 232 executed by the processing resources 240) functionality of a number of the applications 214 (e.g., selected from cloud services executable by a number of sub-providers, among other applications) accessible in the cloud. The connection 227 also can, for example, enable the computing devices 230 to directly and/or indirectly receive input from the number of the applications 214 accessible in the cloud. Moreover, in combination with the functionalities described herein, the connection 227 can, in some examples, provide an interface for revision of the service catalog 228 (e.g., adjustment of prices presented therein, etc.) and/or for accessibility to the service catalog 228 (e.g., by business analysts, authorized representatives, sub-providers, and/or customers, among others).

In various examples, the processing resources 240 coupled to the memory resources 232 and/or 244 can enable the computing devices 230 to execute the MRI 234 to adjust prices presented on a GUI for a number of cloud services provided by (e.g., offered and/or executable by) the cloud service provider to dynamically manage profitability based upon real-time analysis of input profiles. In some examples of the present disclosure, the input profiles include the market price per workload-unit profile, the behavioral profile per customer, the scheduled workload profile per offered cloud service, and the workload capacity profile per cloud service placement option, as described herein. In some examples, the input profiles can include a cost function profile that utilizes at least two of the scaling rule profile per cloud service, the sizing rule profile per cloud service, and/or the cost profile per cloud service placement option, as described herein.

The cost function profile can enable dynamic adjustment of execution resources for the number of cloud services. Dynamic adjustment of the execution of the cloud services can contribute to enabling adjustment of the price presented in the service catalog (e.g., based upon the behavioral profile and/or the contract profile per customer per cloud service, among consideration of other input profile) and/or to enabling an increase in profitability (e.g., the profit margin) for the cloud service provider. For example, adjustment of the execution resources can contribute to a lower price for at least one cloud service (e.g., presented to a customer) and/or a lower cost for the cloud service provider to enhance profitability.

FIG. 3 illustrates a block diagram of an example computing system for dynamic profitability management for cloud service providers according to the present disclosure. The computing system 350 can utilize software, hardware, firmware, and/or logic for dynamic profitability management for cloud service providers, as described herein. The computing system 350 can be any combination of hardware and program instructions. The hardware, for example, can include a number of memory resources 356, processing resources 352, MRM 232, and databases 218, 222, among other components. The computing system 350 can include the memory resources 356, and the processing resources 352 can be coupled to the memory resources 356. Program instructions (e.g., MRI 234) can include instructions stored on the memory resources 356 and executable by the processing resources 352 to perform the actions, functions, calculations, data manipulations and/or storage, etc., as described herein. The memory resources 356 can be in communication with the processing resources 352 via a communication path 354.

The memory resources 356 can be in communication with a number of processing resources of more or fewer than processing resources 352. The processing resources 352 can be in communication with a tangible non-transitory MRM 232 storing a set of MRI 234 executable by the processing resources 352, as described herein. The MRI 234 can also be stored in remote memory resources managed by a server (e.g., in the cloud) and/or can represent an installation package that can be downloaded, installed, and executed.

The processing resources 352 can execute MRI 234 that can be stored on an internal and/or external non-transitory MRM 232 (e.g., in the cloud) in the memory resources 356. The processing resources 352 can execute the MRI 234 to perform the various the actions, functions, calculations, data manipulations and/or storage, etc., as described herein. The MRI 234 can include a number of modules (e.g., 358, 360, . . . , 368, among others described herein) in the memory resources 356. Any number and/or combination of the modules described herein can be stored in memory resources 356. The number of modules can include MRI that when executed by the processing resources 352 can perform the various actions, functions, calculations, data manipulations and/or storage, etc., as described herein.

The number of modules can be sub-modules of other modules. For example, the scheduled workload per offered cloud service module 364 and the workload capacity profile per cloud service placement module 368 can be sub-modules and/or can be contained within the same computing device (e.g., computing device 230). In another example, the number of modules can include individual modules on separate and distinct computing devices (e.g., in the cloud).

A market price profile per workload unit module 358 can include MRI that when executed by the processing resources 352 can perform a number of functions. The market price profile per workload unit module 358 can include instructions that when executed enable, for example, determination and/or storage of a market price profile per workload unit (e.g., as affected by various types and/or amounts of workloads, among other considerations, as described herein), instead of published price lists per workload component (e.g., as determined by analysis of a range of cloud service providers' catalogs, including those of a number of competitors).

A behavioral profile per customer module 360 can include MRI that when executed by the processing resources 352 can perform a number of functions. The behavioral profile per customer module 360 can include instructions that when executed enable, for example, determination and/or storage of, for example, responses by each customer to price adjustments and/or changes in execution related to cloud service offerings.

A scheduled workload profile per offered cloud service module 364 can include MRI that when executed by the processing resources 352 can perform a number of functions. The scheduled workload profile per offered cloud service module 364 can include instructions that when executed enable, for example, determination and/or storage of types and/or amounts of workloads scheduled for each cloud service offered by the cloud service provider and/or sub-providers.

A workload capacity profile per cloud service placement option module 368 can include MRI that when executed by the processing resources 352 can perform a number of functions. The workload capacity profile per cloud service placement option module 368 can include instructions that when executed enable, for example, determination and/or storage of workload capacities for each of a number of cloud services that can be performed at sub-providers located at various placement options (e.g., a capacity and/or ability to handle various amounts and/or types of workloads at a number of cloud service activity sub-providers in a plurality different locations around the world).

In various examples, the memory resources 356 can include a number of other modules that include MRI that when executed by the processing resources 352 can perform a number of functions. For example, a workload timing profile per cloud service module can include MRI that when executed by the processing resources 352 can perform a number of functions. The workload timing profile per cloud service module can include instructions that when executed enable, for example, determination and/or storage of scheduling for jobs (e.g., actually scheduled jobs and/or a forecast of scheduling based upon, for example, historical trends) at various times throughout the day, week, month, year, etc., for each cloud service, or portions thereof, offered by the cloud service provider and/or sub-providers.

In some examples, a contract profile per customer per cloud service module can include MRI that when executed by the processing resources 352 can perform a number of functions. The contract profile per customer per cloud service module can include instructions that when executed enable, for example, determination and/or storage of a contract profile for each customer, which can, for example, include service level agreements and/or agreed upon maximum and minimum costs per service, among other components of business and service contracts. Such contract profiles for each customer can place limits on price and/or execution adjustments for the cloud services.

In some examples, a cost profile per cloud service placement option module can include MRI that when executed by the processing resources 352 can perform a number of functions. The cost profile per cloud service placement option module can include instructions that when executed enable, for example, determination and/or storage of costs to and/or charged by each of the number of cloud service activity sub-providers in various placement options around the world for performing each of the various amounts and/or types of cloud service workloads.

In some examples, a scaling rule profile per cloud service module and/or a sizing rule profile per cloud service module each can include MRI that when executed by the processing resources 352 can perform a number of functions. The scaling rule profile per cloud service module can include instructions that when executed enable, for example, determination and/or storage of rules for adding and/or removing machines (e.g., computers, servers, virtual machines, etc.) as factors in adjusting pricing for particular cloud services and/or adjusting execution of particular cloud services. The sizing rule profile per cloud service module can include instructions that when executed enable, for example, determination and/or storage of rules for replacing machines (e.g., computers, servers, virtual machines, etc.) with other machines having different characteristics (e.g., age, wear level, memory, storage, speed, etc.) as factors in adjusting pricing for particular cloud services and/or adjusting execution of particular cloud services.

In some examples, a cost function profile module can include MRI that when executed by the processing resources 352 can perform a number of functions. The cost function profile module can include instructions that when executed enable, for example, determination and/or storage of a cost function profile that utilizes at least two of the scaling rule profile per cloud service, the sizing rule profile per cloud service, and/or the cost profile per cloud service placement option, as described herein, to enable dynamic adjustment of execution resources for the number of cloud services. Dynamic adjustment of the execution of the cloud services can contribute to enabling adjustment of the price presented in the service catalog and/or to enabling an increase in profitability for the cloud service provider, among other effects of adjusting the execution resources for the each of the cloud services.

In some examples, a service catalog module can include MRI that when executed by the processing resources 352 can perform a number of functions. The service catalog module can include instructions that when executed enable, for example, determination and/or storage of contents of the service catalog. As a result of input and processing content of a number of the other modules, the content of the service catalog (e.g., for cloud services as presentable to every customer and/or as individualized for each customer) can be adjusted for dynamic profitability management for the cloud service providers, as described herein. In some examples, the service catalog module can enable access to the service catalog (e.g., via a number of GUIs) through the connection 227 (e.g., wired and/or wirelessly) to the cloud system 210 illustrated and described with regard to FIG. 2.

In various examples, any of the MRI 234 included in the number of modules (e.g., 358, 360, . . . , 368, among others) can be stored (e.g., in software, firmware, and/or hardware) individually and/or redundantly in the same and/or separate locations. Separately stored MRI 234 can be functionally interfaced (e.g., accessible through the public/private cloud described with regard to FIG. 2). For example, the market price profile per workload unit module 358 may be stored and/or executed in one computing system and the behavioral profile per customer module 360 may be stored and/or executed in another computing system, among many other examples.

In various examples, the processing resources 352 coupled to the memory resources 356 can execute MRI to enable the processing resources 352 to recommend adjustment of prices for a number of cloud services provided by (e.g., offered and/or executable by) a cloud service provider to dynamically manage profitability for the cloud service provider based upon analysis of input profiles, where each of the input profiles can be historical and/or projected profiles (e.g., a record of actually scheduled cloud service jobs and/or a forecast of scheduling based upon, for example, historical trends). In some examples of the present disclosure, the input profiles include the market price profile per workload unit, behavioral profile per customer, the scheduled workload profile per offered cloud service, and the workload capacity profile per cloud service placement option, as described herein. In some examples, each of the profiles can be individualized per customer. For example, the scheduled workload profile per offered cloud service can be individualized to a scheduled workload profile per offered cloud service per customer. Such individualization can enable fine-tuning recommended adjustments to pricing and/or execution of cloud services to particular customers (e.g., consistent with behavioral and/or contact profiles for each customer).

In various examples, a number of additional input profiles usable as input to recommend adjustment of prices and/or execution for the number of cloud services can be selected. The number of additional profiles (e.g., one or more) can be selected from a group that includes, as described herein: the workload timing profile per cloud service, the contract profile per customer per cloud service; the scaling rule profile per cloud service; the sizing rule profile per cloud service; the cost profile per cloud service placement option; and/or the service catalog profile.

In some examples, the input profiles can be updated as determined by changes in profile information and the updated input profiles can be input to the processing resource in real-time. As such, the prices in the service catalog can be updated in real-time based upon the updated input profiles.

Advantages of dynamic profitability management for cloud service providers, as described herein, can include providing an automatic profitability management recommendation that can factor in multiple inputs, such as real-time data (e.g., the workload schedule and capacity of cloud service placement options, the market price profiles per workload units, and/or behavioral profiles per customer, among other input options), and select pricing for cloud service offerings that enhance profitability for the cloud service provider. The selected pricing for each offering can be presented real-time in a service catalog accessible to customers. The dynamic profitability management can provide an advantage, for example, over human analysis in effectiveness and efficiency of the analysis and in an ability to automate updating of prices for cloud service offerings in the service catalog.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource.

As described herein, plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

It is to be understood that the descriptions presented herein have been made in an illustrative manner and not a restrictive manner. Although specific examples systems, machine readable media, methods and instructions, for example, for dynamic profitability management for cloud service providers have been illustrated and described herein, other equivalent component arrangements, instructions, and/or device logic can be substituted for the specific examples presented herein without departing from the spirit and scope of the present disclosure.

The specification examples provide a description of the application and use of the systems, machine readable media, methods, and instructions of the present disclosure. Since many examples can be formulated without departing from the spirit and scope of the systems, machine readable media, methods, and instructions described in the present disclosure, this specification sets forth some of the many possible example configurations and implementations.

What is claimed:

1. A method of dynamic profitability management for cloud service providers, comprising:
utilizing a processing resource to execute instructions stored on a non-transitory medium to:
recommend adjustment of prices for a number of cloud services provided by a cloud service provider to manage profitability based upon analyzing input of input profiles, wherein the input profiles comprise:
a market price profile per workload unit;
a behavioral profile per customer;
a scheduled workload profile per offered cloud service; and
a workload capacity profile per cloud service placement option.

2. The method of claim 1, comprising selecting a number of additional input profiles from a group that comprises:
a workload timing profile per cloud service;
a contract profile per customer per cloud service;
a scaling rule profile per cloud service;
a sizing rule profile per cloud service;
a cost profile per cloud service placement option; and
a service catalog profile.

3. The method of claim 1, comprising automatically adjusting pricing of a number of cloud services presentable to a customer in a service catalog based upon real-time input of the input profiles.

4. The method of claim 1, wherein utilizing comprises to recommend adjustment of execution resources for the number of cloud services based upon analyzing input of input profiles, wherein the input profiles comprise:
the market price profile per workload unit;
the behavioral profile per customer;
the scheduled workload profile per offered cloud service; and
the workload capacity profile per cloud service placement option.

5. The method of claim 4, comprising selecting a number of additional input profiles from a group that comprises:
a workload timing profile per cloud service;
a contract profile per customer per cloud service;
a scaling rule profile per cloud service;
a sizing rule profile per cloud service;
a cost profile per cloud service placement option; and
a service catalog profile.

6. The method of claim 4, comprising automatically adjusting the execution resources of the number of cloud services based upon real-time input of the input profiles.

7. A non-transitory machine-readable medium storing a set of instructions that, when executed, cause a processing resource to:
recommend adjustment of prices for a number of cloud services provided by a cloud service provider to dynamically manage profitability for the cloud service provider based upon analysis of input of historical and projected profiles, wherein the input profiles comprise:
a market price profile per workload unit;
a behavioral profile per customer;
a scheduled workload profile per offered cloud service; and
a workload capacity profile per cloud service placement option.

8. The medium of claim 7, comprising a scheduled workload profile per offered cloud service per customer.

9. The medium of claim 7, comprising a number of additional input profiles selected from a group that comprises:
a workload timing profile per cloud service;
a contract profile per customer per cloud service;
a scaling rule profile per cloud service;
a sizing rule profile per cloud service;
a cost profile per cloud service placement option; and
a service catalog profile.

10. The medium of claim 7, wherein the input profiles are updated as determined by changes in profile information and the updated input profiles are input to the processing resource in real-time.

11. The medium of claim 10, wherein prices in a service catalog are updated in real-time based upon the updated input profiles.

12. A system for dynamic profitability management for cloud service providers, the system comprising a processing resource in communication with a memory resource, wherein the memory resource includes a set of instructions and wherein the processing resource is designed to carry out the set of instructions to:
adjust prices presented on a graphical user interface for a number of cloud services provided by a cloud service provider to dynamically manage profitability based upon real-time analysis of input profiles, wherein the input profiles comprise:
a market price profile per workload unit;
a behavioral profile per customer;
a scheduled workload profile per offered cloud service;
a workload capacity profile per cloud service placement option; and
a cost function profile that utilizes at least two of a scaling rule profile per cloud service, a sizing rule profile per cloud service, and a cost profile per cloud service placement option.

13. The system of claim 12, wherein the cost function profile enables adjustment of execution resources for the number of cloud services.

14. The system of claim 13, wherein adjustment of the execution resources lowers a cost for the cloud service provider to enhance profitability.

15. The system of claim 13, wherein adjustment of the execution resources lowers a price for at least one cloud service.
